(19) United States
(12) Patent Application Publication
(10) Pub. No.: US 2024/0209208 A1
(43) Pub. Date: Jun. 27, 2024

(54) Isotropic Pitch Compositions from Aromatic Feedstocks, Methods of Making the Same, and Uses Thereof

(71) Applicant: ExxonMobil Technology and Engineering Company, Annandale, NJ (US)

(72) Inventors: Ozcan Altintas, Franklin Park, NJ (US); Justin P. Romaire, Brick, NJ (US); Jihad M. Dakka, Whitehouse Station, NJ (US); Renyuan Yu, Humble, TX (US); Anthony S. Mennito, Flemington, NJ (US); Brandon M. Carcuffe, Hackettstown, NJ (US); Teng Xu, Houston, TX (US)

(73) Assignee: ExxonMobil Technology and Engineering Company, Annandale, NJ (US)

(21) Appl. No.: 18/279,805

(22) PCT Filed: Nov. 10, 2021
(86) PCT No.: PCT/US2021/072322

§ 371 Date: Aug. 31, 2023

Related U.S. Application Data
(60) Provisional application No. 63/167,354, filed on Mar. 29, 2021.

(51) Int. Cl. C08L 95/00

(52) U.S. Cl. CPC C08L 95/00; C08L 2555/74

(57) ABSTRACT

Isotropic pitch compositions may be obtained by reacting an aromatic feedstock comprising one or more aromatic classes with formaldehyde or paraformaldehyde under acidic conditions. Isotropic pitch compositions may comprise: at least two monomers linked with at least one methylene bridge between each one of the at least two monomers, wherein each one of the at least monomers comprises one or more aromatic classes comprising one or more 5-membered rings, 6-membered rings, and any combination thereof; and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition.

### FIELD OF THE INVENTION

The present disclosure relates to acid-mediated production of isotropic pitch compositions from aromatic hydrocarbon feedstocks, methods of making the same, and uses thereof.

### BACKGROUND OF THE INVENTION

Carbon fibers market has grown significantly over the past decade, which can be attributed to the increasing demand from a wide range of industries such as automotive (e.g., body parts such as deck lids, hoods, front end, bumpers, doors, chassis, suspension systems such as leaf springs, drive shafts), aerospace (such as aircraft and space systems), high performance aquatic vessels (such as yachts and rowing shells), airplanes, sports equipment (e.g., golf club, tennis racket, ski boards, snowboards, helmets, rowing or water skiing equipment), construction (non-structural and structural systems), military (e.g., flying drones, armor, armored vehicles, military aircraft), wind energy industries, energy storage applications, fireproof materials, carbon-carbon composites, carbon fibers, and in many insulating and sealing materials used in construction and road building (e.g., concrete), turbine blades, light weight cylinders and pressure vessels, off-shore tethers and drilling risers, medical, for example. The non-limiting properties of the carbon fibers make such material suitable for high-performance applications: high bulk modulus and tensile modulus (depending on the morphology of the carbon fiber), high electrical and thermal conductivities, high specific density, etc. However, the high cost of carbon fiber limits its applications and widespread use, in spite of the remarkable properties exhibited by such material. Hence, developing low-cost technologies to produce carbon fibers has been a major challenge for researchers and key manufacturers.

Highly oriented carbon fibers with excellent mechanical properties from pitch precursors has been a long-standing goal in the petrochemical industry. The ultrahigh tensile modulus of mesophase pitch-based carbon fibers are attributable to the highly oriented aromatic molecules with planar liquid crystal structure in the parent mesophase pitches. Petroleum byproducts with abundant aromatic fractions have been commonly used to produce mesophase pitch. However, oftentimes, such production process requires toxic and aggressive conditions such as the use of super-acids (e.g., HF/BF₃ or AlCl₃). Moreover, the harsh acidic conditions and difficulties to produce highly pure pitch materials limit the wide application of the current processes. Further, the mechanical properties of pitch-based carbon fibers depend on the orientation and uniformity of precursor pitch fibers and the purity of the pitch itself.

Factors that may dictate the suitability of a pitch composition precursor for an intended application (e.g., mesophase pitch production, carbon fibers manufacture, etc.), include, for example, softening point, molecular weight, sulfur content of less than 0.5 wt %, mesophase content >80%, coking value (MCR >80%), inorganic particles content of less than 10 ppm, viscosity, density, melting point, as well as secondary performance factors influenced by these parameters. Although pitch compositions having a wide range of physical properties may be desirable for use in various types of applications, there is not presently a ready way of producing high-quality synthetic isotropic pitch compositions, particularly with the ability to tune structural and other physical properties needed for addressing certain application-specific needs.

### SUMMARY OF THE INVENTION

The present disclosure relates to acid-mediated production of isotropic pitch compositions from aromatic hydrocarbon feedstocks, methods of making the same, and uses thereof.

Disclosed herein are isotropic pitch compositions that comprise: at least two monomers linked with at least one methylene bridge between each one of the at least two monomers, wherein each one of the at least monomers comprises one or more aromatic classes comprising one or more 5-membered rings, 6-membered rings, and any combination thereof; and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition.

Disclosed herein are methods that comprise: mixing an aromatic feedstock comprising one or more aromatic classes with formaldehyde or paraformaldehyde, in the presence of acetic acid at ambient temperature to produce a first mixture; heating the first mixture at a temperature of about 40° C. to about 300° C.; mixing a second mixture comprising sulfuric acid and acetic acid to the first mixture at a temperature of about 40° C. to about 300° C. to form a mix comprising an isotropic pitch composition, wherein the isotropic pitch composition comprises: at least two monomers linked with at least one methylene bridge between each one of the at least two monomers, wherein each one of the at least monomers comprises the one or more aromatic classes comprising one or more 5-membered rings, 6-membered rings, and any combination thereof, and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition.

Disclosed herein are methods that comprise: mixing an aromatic feedstock comprising one or more aromatic classes with formaldehyde or paraformaldehyde, in the presence of acetic acid at ambient temperature to produce a first mixture; heating the first mixture at a temperature of about 40° C. to about 300° C.; mixing a second mixture comprising sulfuric acid and acetic acid to the first mixture at a temperature of about 40° C. to about 300° C. to form a mix comprising an isotropic pitch composition, wherein the isotropic pitch composition comprises: at least two monomers linked with at least one methylene bridge between each one of the at least two monomers, wherein each one of the at least monomers comprises the one or more aromatic classes comprising one or more 5-membered rings, 6-membered rings, and any combination thereof; wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition; and hydrotreating the isotropic pitch composition to produce a mesophase pitch suitable for spinning into carbon fibers.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a 400 MHz ¹H NMR spectrum of an isotropic 1-methyl naphthalene pitch composition in CDCl₃, in accordance with some embodiments of the present disclosure.

FIG. 2 is a 400 MHz ¹³C NMR spectrum of an isotropic 1-methyl naphthalene pitch composition in CDCl₃, in accordance with some embodiments of the present disclosure.

FIG. 3 is a Fourier-transform ion cyclotron resonance (FT-ICR) mass spectrum of isotropic 1-methyl naphthalene pitch composition, in accordance with some embodiments of the present disclosure.

FIG. 4 is a mass spectrum of the isotropic toluene pitch composition, in accordance with some embodiments of the present disclosure.

FIG. 5 is a mass spectra of the isotropic phenanthrene pitch composition, in accordance with some embodiments of the present disclosure.

FIG. 6 is a mass spectra of the pyrene pitch composition, in accordance with some embodiments of the present disclosure.

FIG. 7 is a mass spectra of the AR-200, in accordance with some embodiments of the present disclosure.

FIG. 8 is a mass spectra of an isotropic pitch composition comprising a mixture of naphthalene and phenanthrene, in accordance with some embodiments of the present disclosure.

### DETAILED DESCRIPTION OF THE INVENTION

The present disclosure relates to acid-mediated production of isotropic pitch compositions from aromatic hydrocarbon feedstocks, methods of making the same, and uses thereof (e.g., conversion into mesophase pitches for carbon fiber manufacture).

As discussed above, there is growing demand for pitches in a variety of industries, especially high-quality pitches, such as those suitable for making carbon fibers or normal paraffin hydrocarbon (NPH) products, for example. At present, there are no synthetic options available for producing high-quality isotropic pitch compositions, particularly with the ability to tune their structural, physical, and mechanical properties of the pitch compositions to meet particular application-specific needs.

Embodiments of the present disclosure include isotropic pitch compositions comprising: at least two monomers linked with at least one methylene bridge between each one of the at least two monomers, wherein each one of the at least monomers comprises one or more aromatic classes comprising one or more 5-membered rings, 6-membered rings, and any combination thereof, and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition. The isotropic pitch compositions of the present disclosure are methylene-bridged aromatic oligomers produced by reacting aromatic feedstocks with formaldehyde or paraformaldehyde in the presence of acetic acid and sulfuric acid. Herein, the aromatic classes may comprise: unsubstituted aromatics and/or substituted aromatics selected from the group consisting of 1-ring aromatics (ARC1), 2-ring aromatics (ARC2), 3-ring aromatics (ARC3), 4 or more-ring aromatics (ARC4), 5-ring aromatics (ARC5), 6-ring aromatics (ARC6), 7-ring aromatics (ARC7), 8-ring aromatics (ARC8), 9-ring aromatics (ARC9), 10 or more-ring aromatics (ARC10+), and any combination thereof. The substituted aromatics can be selected from the group consisting of C₁ to C₂₀ hydrocarbyl monosubstituted aromatics, C₁ to C₂₀ hydrocarbyl disubstituted aromatics, C₁ to C₂₀ hydrocarbyl trisubstituted aromatics, and any combination thereof, such as the substituted aromatics can be selected from the group consisting of C₁ to C₁₀ hydrocarbyl monosubstituted aromatics, C₁ to C₁₀ hydrocarbyl disubstituted aromatics, C₁ to C₁₀ hydrocarbyl trisubstituted aromatics, and any combination thereof, such as the substituted aromatics can be selected from the group consisting of C₁ to C₅ hydrocarbyl monosubstituted aromatics, C₁ to C₅ hydrocarbyl disubstituted aromatics, C₁ to C₅ hydrocarbyl trisubstituted aromatics, and any combination thereof The isotropic pitch compositions can be produced from well-defined, highly pure, and cost-effective substituted and/or non-substituted single-ring aromatic feedstocks, substituted and/or non-substituted polycyclic aromatic hydrocarbon (PAH) feedstocks, and any combination thereof. PAH may include two-ring aromatic feedstocks or multi-ring aromatic feedstocks (e.g., three ring aromatic feedstocks or greater).

Another aspect of the present disclosure relates to the methods for making the isotropic pitch compositions comprising: mixing an aromatic feedstock comprising one or more aromatic classes with paraformaldehyde, in the presence of acetic acid at ambient temperature to produce a first mixture; heating the first mixture at a temperature of about 40° C. to about 300° C.; and mixing a second mixture comprising sulfuric acid and acetic acid to the first mixture at a temperature of about 40° C. to about 300° C. to form a mix comprising an isotropic pitch composition, wherein the isotropic pitch composition comprises: at least two monomers linked with at least one methylene bridge between each one of the at least two monomers, wherein each one of the at least monomers comprises one or more aromatic classes comprising one or more 5-membered rings, 6-membered rings, and any combination thereof, and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition.

Further, the isotropic pitch composition may have a weight average molecular weight (Mw) of about 300 g/mol to about 750 g/mol. The isotropic pitch composition may comprise or consist essentially of dimers, trimers, tetramers, pentamers, and any combination thereof. In some cases, the isotropic pitch composition may comprise or consist essentially of trimers and tetramers.

The reaction conditions of the methods herein are very critical for the molecular weight distribution and the softening point of the isotropic pitch compositions. Advantageously, methods of the present disclosure enables to control both properties by tuning the molar ratio of sulfuric acid and formaldehyde (or paraformaldehyde). The softening points of the isotropic pitch compositions can increase particularly with reaction time, the amount of sulfuric acid and formaldehyde (or paraformaldehyde). Further, little to no water is present in the reaction mixture, and any residual acids can be easily removed by filtration after washing the residue comprising the isotropic pitch composition with basic solution, thus facilitating the isolation of the said isotropic pitch composition as a highly pure material (i.e., starting materials quantitatively consumed, confirmed by mass spectrometry, ¹H NMR, and ¹³C NMR spectra).

Methods of the present disclosure are a nondehydrogenative synthetic route which provides a facile pathway for the production of pitch precursors for the manufacturing of advanced carbon products. Further, methods of the present disclosure advantageously provide a way of producing high-quality synthetic isotropic pitch compositions, particularly with the ability to tune structural and other physical properties needed for addressing certain application-specific needs. Said isotropic pitch compositions of the present disclosure may be used as precursors of mesophase pitches for carbon fiber manufacture to improve the production of highly oriented carbon fibers with excellent mechanical properties, as well as normal paraffin hydrocarbons, or tackifiers.

### Definitions and Test Methods

For the purposes of the present disclosure, the new numbering scheme for groups of the Periodic Table is used. In said numbering scheme, the groups (columns) are numbered sequentially from left to right from 1 through 18. The new numbering scheme for the Periodic Table Groups is used as described in Chemical and Engineering News, v. 63(5), pg. 27 (1985). Therefore, a “group 14” is an element from group 14 of the Periodic Table, e.g., C, Si, or Ge.

All numerical values within the detailed description and the claims herein are modified by “about” or “approximately” with respect to the indicated value, and take into account experimental error and variations that would be expected by a person having ordinary skill in the art. Unless otherwise indicated, ambient temperature (room temperature) is about 25° C.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure and the claims thereto, the following definitions shall be used.

“Conversion” is the percentage of a monomer that is converted to polymer product in a polymerization, and is reported as % and is calculated based on the polymer yield, the polymer composition, and the amount of monomer fed into the reactor.

Unless otherwise specified, the term “Cₙ” means hydrocarbon(s) having n carbon atom(s) per molecule, wherein n is a positive integer.

The term “Cₙ” group or compound refers to a group or a compound comprising carbon atoms at total number thereof of n. Thus, a “Cₘ-Cₙ” group or compound refers to a group or compound comprising carbon atoms at a total number thereof in the range from m to n. Thus, a C₁-C₅₀ alkyl group refers to an alkyl group comprising carbon atoms at a total number thereof in the range from 1 to 50.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthalenyl, and the like.

The term “aryl” or “aryl group” means an aromatic ring (typically made of 6 carbon atoms) and the substituted variants thereof, such as phenyl, 2-methyl-phenyl, xylyl, 4-bromo-xylyl, for example. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

The term “substituted aromatic,” means an aromatic group having 1 or more hydrogen groups replaced by a hydrocarbyl, heteroatom or heteroatom containing group.

The term “ring atom” means an atom that is part of a cyclic ring structure. By this definition, a benzyl group has six ring atoms and tetrahydrofuran has 5 ring atoms.

A heterocyclic ring, also referred to as a heterocyclic, is a ring having a heteroatom in the ring structure as opposed to a “heteroatom-substituted ring” where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring means a heterocyclic ring having 1 or more hydrogen groups replaced by a hydrocarbyl, heteroatom or heteroatom containing group.

The terms “alkyl radical,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tertbutyl).

The terms “linear” or “linear hydrocarbon” refer to a hydrocarbon or hydrocarbyl group having a continuous carbon chain without side chain branching, in which the continuous carbon chain may be optionally substituted.

The terms “cyclic” or “cyclic hydrocarbon” refer to a hydrocarbon or hydrocarbyl group having a closed carbon ring, which may be optionally substituted. The term “carbocyclic” may also synonymously refer to such a hydrocarbon or hydrocarbyl group.

The terms “branched” or “branched hydrocarbon” refer to a hydrocarbon or

hydrocarbyl group having a linear carbon chain or a closed carbon ring, in which a hydrocarbyl side chain extends from the linear carbon chain or the closed carbon ring. Optional substitution may be present in the linear carbon chain, the closed carbon ring, and/or the hydrocarbyl side chain.

The terms “saturated” or “saturated hydrocarbon” refer to a hydrocarbon or hydrocarbyl group in which all carbon atoms are bonded to four other atoms, with the exception of an unfilled valence position being present upon carbon in a hydrocarbyl group.

The terms “unsaturated” or “unsaturated hydrocarbon” refer to a hydrocarbon or hydrocarbyl group in which one or more carbon atoms are bonded to less than four other atoms, exclusive of an open valence position upon carbon being present. That is, the term “unsaturated” refers to a hydrocarbon or hydrocarbyl group bearing one or more double and/or triple bonds, with the double and/or triple bonds being between two carbon atoms and/or between a carbon atom and a heteroatom.

The terms “aromatic” or “aromatic hydrocarbon” refer to a hydrocarbon or hydrocarbyl group having a cyclic arrangement of conjugated pi-electrons that satisfies the Hückel rule.

The term “independently,” when referenced to selection of multiple items from within a given Markush group, means that the selected choice for a first item does not necessarily influence the choice of any second or subsequent item. That is, independent selection of multiple items within a given Markush group means that the individual items may be the same or different from one another.

Examples of saturated hydrocarbyl groups include, but are not limited to, methyl, ethyl, n-propyl, isopropyl, n-butyl, isobutyl, sec-butyl, tert-butyl, pentyl, iso-amyl (isopentyl), neopentyl, hexyl, octyl cyclopropyl, cyclobutyl, cyclopentyl, cyclohexyl, cyclooctyl, and the like, including their substituted analogues. Examples of unsaturated hydrocarbyl groups include, but are not limited to, ethenyl, propenyl, allyl, 1,4-butadienyl, cyclopropenyl, cyclobutenyl, cyclopentenyl, cyclohexenyl, cyclooctenyl and the like, including their substituted analogues.

Examples of aromatic hydrocarbyl groups include, but are not limited to, phenyl, tolyl, xylyl, naphthyl, and the like. Heteroaryl and polynuclear heteroaryl groups may include, but are not limited to, pyridyl, quinolinyl, isoquinolinyl, pyrimidinyl, quinazolinyl, acridinyl, pyrazinyl, quinoxalinyl, imidazolyl, benzimidazolyl, pyrazolyl, benzopyrazolyl, oxazolyl, benzoxazolyl, isoxazolyl, benzisoxazolyl, imidazolinyl, thiophenyl, benzothiophenyl, furanyl and benzofuranyl. Polynuclear aryl groups may include, but are not limited to, naphthalenyl, anthracenyl, indanyl, indenyl, and tetralinyl.

Unless specified otherwise, the term “substantially free of” with respect to a particular component means the concentration of that component in the relevant composition is no greater than 5 mol % (such as no greater than 3 mol %, no greater than 1 mol %, or about 0%, within the bounds of the relevant measurement framework), based on the total quantity of the relevant composition.

The term “isolated” refers to the condition of a substance being obtained in a state substantially free of solvent and/or precursors to the given substance.

As used herein, Mw is weight average molecular weight, wt % is weight percent, and mol % is mole percent. Unless otherwise noted, molecular weight unit (e.g., Mw) is g/mol.

Unless otherwise indicated, the term “room temperature”, also referred to as “ambient temperature”, is approximately 23° C.

The “microcarbon residue test”, also referred to as “MCRT”, is a standard test method for the determination of carbon residue (micro method). The carbon residue value of the various petroleum materials serves as an approximation of the tendency of the material to form carbonaceous type deposits under degradation conditions similar to those used in the test method, and can be useful as a guide in manufacture of certain stocks. However, care needs to be exercised in interpreting the results. This test method covers the determination of the amount of carbon residue formed after evaporation and pyrolysis of petroleum materials under certain conditions and is intended to provide some indication of the relative coke forming tendency of such materials. Herein, the MCRT is measured according to the ASTM D4530-15 standard test method, using METTLER TOLEDO DP70 dropping point instrument, such as METTLER TOLEDO DP70.

As used herein, a “glass transition temperature” (Tg) refers to a mid-point of the temperature at which a continuous step change in heat capacity (or peak at the first derivative of heat flow) is recorded on the second heating scan of a differential scanning calorimeter (DSC) experiment at 10° C./min heating and cooling rate. For purposes of the disclosure herein, Tg may be measured using thermal analysis TA INSTRUMENTS Q2000™, as indicated. DSC data analysis was performed using TA Instruments TRIOS software using the second heating curve.

The “softening point” refers to a temperature or a range of temperatures at which a substance softens. Herein, the softening point (SP) is measured using a METTLER TOLEDO dropping point instrument, such as METTLER TOLEDO DP70, according to a procedure analogous to ASTM D3104. Unless otherwise indicated, ¹H and ¹³C Nuclear Magnetic Resonance (NMR) spectra of the pitch compositions can be obtained using either a 400 MHz BRUKER AVANCE™ III HD spectrometer. Chemical shifts were referenced to tetramethylsilane (TMS) as an internal standard at 0.00 ppm for ¹H spectra taken in CDCl₃ containing 0.03% (v/v) TMS.

The following abbreviations may be used through the present disclosure and claims: MCRT is microcarbon residue test, equiv is molar equivalent, ppm is parts per million, Tg is glass transition temperature; Tsp is softening point temperature.

### Isotropic Pitch Compositions and Methods for Making the Same

An isotropic pitch composition of the present disclosure may comprise: at least two monomers linked with at least one methylene bridge between each one of the at least two monomers, wherein each one of the at least monomers comprises one or more aromatic classes, and wherein the isotropic pitch composition has a weight average molecular weight (Mw) of about 300 g/mol to about 1,500 g/mol (or about 300 g/mol to about 750 g/mol), a softening point (Tₛₚ) of 90° C. or greater, and a micro carbon residue (MCR) of about 18 wt % or greater, based on the total weight of the isotropic pitch composition.

The isotropic pitch composition formed comprises a distribution of products, including dimers, trimers, and higher oligomers. Further, the isotropic pitch composition may have a weight average molecular weight (Mw) of about 300 g/mol to about 750 g/mol, wherein the isotropic pitch composition may comprise or consist essentially of dimers, trimers, tetramers, pentamers, and any combination thereof. In some cases, the isotropic pitch composition may comprise or consist essentially of trimers and tetramers.

The isotropic pitch compositions can be produced from well-defined, highly pure, and cost-effective substituted and/or non-substituted single-ring aromatic feedstocks, substituted and/or non-substituted polycyclic aromatic hydrocarbon (PAH) feedstocks, and any combination thereof. PAH may include two-ring aromatic feedstocks or multi-ring aromatic feedstocks (e.g., three ring aromatic feedstocks or greater). PAH can be a mixture of the above hydrocarbons such as AROMATIC-200™.

The one or more aromatic classes can be unsubstituted aromatics and/or substituted aromatics selected from the group consisting of 1-ring aromatics (ARC1), 2-ring aromatics (ARC2), 3-ring aromatics (ARC3), 4 or more-ring aromatics (ARC4), 5-ring aromatics (ARC5), 6-ring aromatics (ARC6), 7-ring aromatics (ARC7), 8-ring aromatics (ARC8), 9-ring aromatics (ARC9), 10 or more-ring aromatics (ARC10+), and any combination thereof.

The substituted aromatics can be selected from the group consisting of C₁ to C₂₀ hydrocarbyl monosubstituted aromatics, C₁ to C₂₀ hydrocarbyl disubstituted aromatics, C₁ to C₂₀ hydrocarbyl trisubstituted aromatics, and any combination thereof, such as the substituted aromatics can be selected from the group consisting of C₁ to C₁₀ hydrocarbyl monosubstituted aromatics, C₁ to C₁₀ hydrocarbyl disubstituted aromatics, C₁ to C₁₀ hydrocarbyl trisubstituted aromatics, and any combination thereof, such as the substituted aromatics can be selected from the group consisting of C₁ to C₅ hydrocarbyl monosubstituted aromatics, C₁ to C₅ hydrocarbyl disubstituted aromatics, C₁ to C₅ hydrocarbyl trisubstituted aromatics, and any combination thereof.

Nonlimiting examples of aromatic feedstocks may comprise benzene, toluene, xylenes (e.g., ortho-, meta-, para-substituted xylene), naphthalene, 1-methylnaphthalene, 2-methylnaphthalene, 3-methylnaphthalene, 2,6-dimethylnaphthalene, 1-ethylnaphthalene, 2-ethylnaphthalene, 1,7-diisopropylnaphthalene, 2,3-diisopropylnaphthalene, 2,6-diisopropylnaphthalene, 2,7-diisopropylnaphthalene, 1-butylnaphthalene, 2-butylnaphthalene, 1-tert-butylnaphthalene, 2-tert-butylnaphthalene, anthracene, 1-methylanthracene, 2-methylanthracene, 9-methylanthracene, 9,10-dimethylanthracene, 9,10-diphethylanthracene, phenanthrene, 1-methylphenanthrene, 1-ethylphenanthrene, 2-methylphenanthrene, 1-phenylphenanthrene, 2,7-diphenylphenanthrene, pyrene, 1-propylpyrene, 4-propylpyrene, 1,2,3-trimethylpyrenebenzopyrene, picenecoronene, chrysene, tetracene, pentacene, triphenylene, corannulene, fluorine, benzo[j]fluoranthene, Benzo[c]fluorene, perylene, benzo-perylene, ovalene, AROMATIC-200™, acenaphthene, and any isomers thereof, and any combination thereof.

Preferable are aromatic hydrocarbons or heterocyclic aromatic compounds containing 1 to 3 rings and they may be substituted by alkyl groups containing 1 to 6 carbon atoms, phenyl group, or aralkyl groups containing 7 to 9 carbon atoms. Here, an aromatic hydrocarbon is advantageously selected from xylene, naphthalene, methylnaphthalene, dimethylnaphthalene, biphenyl, anthracene, phenanthrene, pyrene and their derivatives substituted with alkyl groups containing 1 to 6 carbon atoms. More preferable are polycyclic aromatic hydrocarbons such as naphthalene, methylnaphthalene and dimethylnaphthalene and mixtures of these polycyclic aromatic hydrocarbons such as aromatic oils.

In the cases where a polycyclic aromatic compound is used as a reactant, the compound, for example, may be an aromatic hydrocarbon oil containing 90 wt % or more of naphthalene, high-purity naphthalene or an aromatic hydrocarbon oil mainly containing naphthalene. Available as such hydrocarbon oils are the naphthalene oil fraction, methylnaphthalene oil fraction and intermediate oil fraction derived from coal tar or the intermediate products and residual oils obtained by recovering the principal components of these fractions by distillation, extraction and the like. These naphthalene- or methylnaphthalene-containing oils often occur as mixtures of the principal components and polycyclic aromatic hydrocarbons whose boiling points are close to each other. An aromatic hydrocarbon to be used in the reaction can be a mixture unless a pure raw material is used.

A naphthalene-containing aromatic hydrocarbon oil naturally contains aromatic hydrocarbons as main components and may additionally contain heterocyclic aromatic compounds having N, S, O and the like in the ring, aromatic compounds having functional groups containing the said heteroatoms or inert aliphatic hydrocarbons. An aromatic hydrocarbon oil containing 90 wt % or more of naphthalene may be refined naphthalene, but a preferred example is 95% grade naphthalene. This particular material contains benzothiophene, methylnaphthalene and the like in addition to naphthalene.

The one or more aromatic classes may comprise partially hydrogenated aromatic rings, such as tetralin (also referred to as “1,2,3,4-tetrahydronaphthalene”) or indene, for example. The one or more aromatic classes may be substituted with one or more alkyl groups having 1 to 10 carbons, such as methyl, ethyl, propyl, butyl, pentyl, hexyl, heptyl, octyl, nonyl, decyl, and isomers thereof. The alkyl group may be straight chain, branched, or cyclic. The alkyl group may be saturated or unsaturated. In some embodiments, the alkyl group may include at least one aromatic group.

Formaldehyde to be used in the methods of the present disclosure may be formaldehyde itself or a compound which is capable of generating formaldehyde in the reaction system and formaldehyde, formalin, paraformaldehyde and the like can be used. It is advantageous to use paraformaldehyde.

Nonlimiting examples of acids may comprise sulfuric acid, hydrochloric acid, nitric acid, acetic acid, phosphoric acid, citric acid, carbonic acid, oxalic acid, aromatic sulfonic acid.

The isotropic pitch composition of the present disclosure may comprise: 0.1 wt % to 100 wt % ARC1, 0.1 wt % to 100 wt % ARC2, 0.1 wt % to 100 wt % ARC3, 0.1 wt % to 100 wt 5% ARC4, 0.1 wt % to 100 wt % ARC5, 0.1 wt % to 100 wt % ARC6, 0.1 wt % to 100 wt % ARC7, 0.1 wt % to 100 wt % ARC8, 0.1 wt % to 100 wt % ARC9, 0.1 wt % to 100 wt % ARC10+, based on the total weight of the isotropic pitch composition.

The isotropic pitch composition of the present disclosure may comprise 0.1 wt % to 100 wt % ARC1 (0.1 wt % to 95 wt %, or 0.5 wt % to 90 wt %, or 1 wt % to 85 wt %, or 5 wt % to 80wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC2 (0.1 wt % to 95 wt %, or 0.5 wt % to 90 wt %, or 1 wt % to 85 wt %, or 5 wt % to 80 wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC3 (0.1 wt % to 95 wt %, or 0.5 wt % to 90 wt %, or 1 wt % to 85 wt %, or 5 wt % to 80 wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC4 (0.1 wt % to 95 wt %, or 0.5 wt % to 90 wt %, or 1 wt % to 85 wt %, or 5 wt % to 80 wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC5 (0.1 wt % to 95 wt %, or 0.5 wt % to 90 wt %, or 1 wt % to 85 wt %, or 5 wt % to 80 wt %,or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %,or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC6 (0.1 wt % to 95 wt %, or 0.5 wt % to 90 wt %, or 1 wt % to 85 wt %, or 5 wt % to 80 wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC7 (0.1 wt % to 95 wt %, or 0.5 wt % to 90 wt %, or 1 wt % to 85 wt %, or 5 wt % to 80 wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC8 (0.1 wt % to 95 wt %, or 0.5 wt % to 90 wt %, or 1 wt % to 85 wt %, or 5 wt % to 80 wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC9 (0.1 wt % to 95 wt %, or 0.5 wt % to 90 wt %, or 1 wt % to 85 wt %, or 5 wt % to 80 wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %,or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC10+ (0.1 wt % to 95 wt %, or 0.5 wt % to 90 wt %, or 1 wt % to 85 wt %, or 5 wt % to 80 wt %, or 10 wt % to 75 wt %, or 15 wt % to 70 wt %, or 20 wt % to 65 wt %, or 25 wt % to 60 wt %, or 30 wt % to 55 wt %, or 35 wt % to 50 wt %, or 40 wt % to 45 wt %, or 0.1 wt % to 50 wt %, or 0.5 wt % to 45 wt %, or 1 wt % to 40 wt %, or 1.5 wt % to 35 wt %, or 2 wt % to 30 wt %, or 2.5 wt % to 25 wt %, or 3 wt % to 20 wt %), based on the total weight of the isotropic pitch composition.

The isotropic pitch composition of the present disclosure may comprise: 0.1 wt % to 100 wt % ARC1, 0.1 wt % to 100 wt % ARC2, 0.1 wt % to 80 wt % ARC3, 0.1 wt % to 50 wt % ARC4, 0.1 wt % to 50 wt % ARC5, 0.1 wt % to 25 wt % ARC6, 0.1 wt % to 25 wt % ARC7, 0 wt % to 10 wt % ARC8, 0 wt % to 10 wt % ARC9, 0 wt % to 5 wt % ARC10+, based on the total weight of the isotropic pitch composition.

Further, the isotropic pitch composition may have a Tₛₚ of about 500° C. or less (or from about 90° C. to about 500° C., or from about 100° C. to about 490° C., or from about 110° C. to about 480° C., or from about 120° C. to about 470° C., or from about 130° C. to about 460° C., or from about 140° C. to about 450° C., or from about 150° C. to about 440° C., or from about 160° C. to about 430° C., or from about 170° C. to about 420° C., or from about 180° C. to about 410° C., or from about 200° C. to about 400° C.). In some cases, the isotropic pitch composition may have a Tₛₚ of about 400° C. or less, such as about 350° C. or less, such as about 300° C. or less, such as about 250° C. or less, such as about 200° C. or less.

The isotropic pitch composition may have a transition glass temperature (T_{g}) ranging from about 50° C. to about 200° C. (or from about 60° C. to about 180° C., or from about 70° C. to about 160° C., or from about 80° C. to about 140° C., or from about 90° C. to about 120° C., or from about 50° C. to about 100° C., or from about 100° C. to about 200° C.).

The isotropic pitch composition may have an MCR of about 40 wt % or less (or 35 wt % or less, or 30 wt % or less), based on the total weight of the isotropic pitch composition. The isotropic pitch composition may have an MCR of from about 18 wt % to about 40 wt %, based on the total weight of the isotropic pitch composition.

The isotropic pitch composition may have an Mw of about 300 g/mol to about 1,500 g/mol (or about 400 g/mol to about 1,200 g/mol, or about 500 g/mol to about 1,000 g/mol, or about 600 g/mol to about 800 g/mol, or about 300 g/mol to about 1,000 g/mol, or about 300 g/mol to about 500 g/mol). Alternately, the isotropic pitch composition may have an Mw of about 500 g/mol or less (or about 100 g/mol to about 500 g/mol, or about 150 g/mol to about 400 g/mol, or about 200 g/mol to about 350 g/mol, or about 250 g/mol to about 300 g/mol, or about about 100 g/mol to about 250 g/mol, or about 250 g/mol to about 500 g/mol).

Methods for making the isotropic pitch compositions described above may comprise: mixing an aromatic feedstock comprising one or more aromatic classes with paraformaldehyde, in the presence of acetic acid at ambient temperature to produce a first mixture; heating the first mixture at a temperature of about 40° C. to about 300° C.; and mixing a second mixture comprising sulfuric acid and acetic acid to the first mixture at a temperature of about 40° C. to about 300° C. to form a mix comprising an isotropic pitch composition, wherein the isotropic pitch composition comprises: at least two monomers linked with at least one methylene bridge between each one of the at least two monomers, wherein each one of the at least monomers comprises one or more aromatic classes, and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition. Without being bound by any theory, it is believed that the reaction may be initiated via Friedel-Craft acylation reaction, followed by condensation reactions.

Further, the isotropic pitch composition may have a weight average molecular weight (Mw) of about 300 g/mol to about 750 g/mol, wherein the isotropic pitch composition may comprise or consist essentially of dimers, trimers, tetramers, pentamers, and any combination thereof. In some cases, the isotropic pitch composition may comprise or consist essentially of trimers and tetramers.

A nonlimiting example of an isotropic pitch composition can be produce from an aromatic feedstock comprising toluene. The resulting toluene-containing isotropic pitch composition can be represented in Scheme 1.

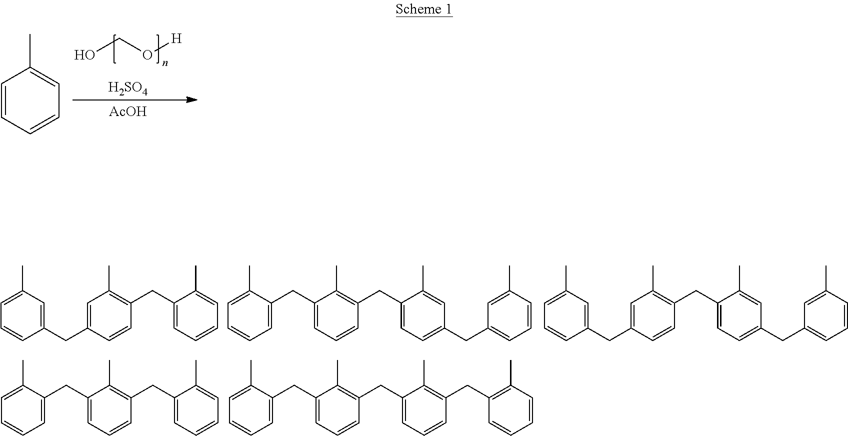

Another nonlimiting example of an isotropic pitch composition can be produce from an aromatic feedstock comprising para-xylene. The resulting para-xylene-containing isotropic pitch composition can be represented in Scheme 2.

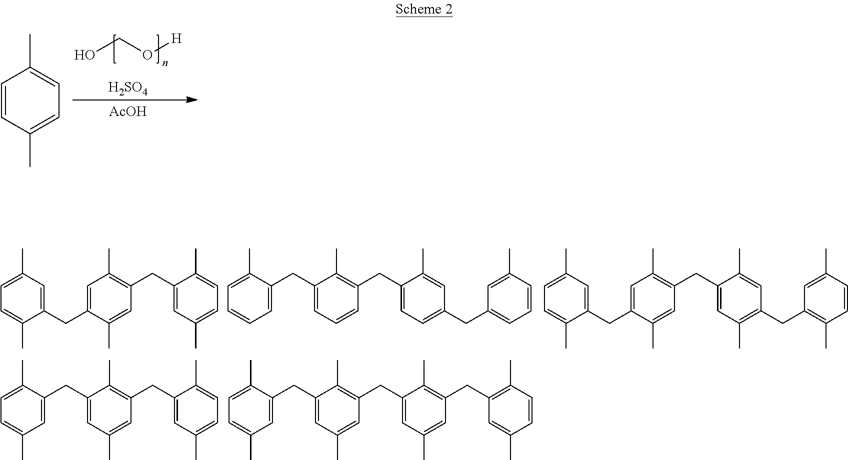

Mixing the aromatic feedstock and paraformaldehyde can be carried out at a molar ratio aromatic feedstock: formaldehyde (or paraformaldehyde) of from about 10:1 to about 1:10 (or about 1:1 to about 1:10, or about 1:1.5 to about 1:9, or about 1:2 to about 1:8, or about 1:2.5 to about 1:7, or about 1:3 to about 1:6, or about 1:4 to about 1:5). In at least one embodiment, the molar ratio aromatic feedstock: paraformaldehyde is 1:3. Notwithstanding, the paraformaldehyde molar ratio is based on the formaldehyde molar equivalent.

Further, the addition of sulfuric acid can be carried out at a molar ratio aromatic feedstock: sulfuric acid of from about 1:0.001 to about 1:20 (or about 1:0.01 to about 1:19, or about 1:0.1 to about 1:18, or about 1:0.5 to about 1:17, or about 1:1 to about 1:16, or about 1:1.5 to about 1:15, or about 1:2 to about 1:14, or about 1:2.5 to about 1:13, or about 1:3 to about 1:12, or about 1:3.5 to about 1:11, or about 1:4 to about 1:10). In at least one embodiment, the molar ratio aromatic feedstock: sulfuric acid is 1:1.

The of mixing the second mixture comprising sulfuric acid and acetic acid to the first mixture comprising the an aromatic feedstock and paraformaldehyde can be carried out at a temperature of about 40° C. to about 300° C., such as about 50° C. to about 100° C., such as about 60° C. to about 80° C., such as about 40° C. to about 60° C., such as about 60° C. to about 90° C., for a time period of about 5 hours or less (or about 5 minutes to about 5 hours, or about 10 minutes to about 4 hours, or about 15 minutes to about 3 hours, or about 20 minutes to about 2 hours, or about 25 minutes to about 1 hours, or about 30 minutes, for example), although the conditions may vary with the raw materials and acids in use.

Separating the isotropic pitch composition from any remaining paraformaldehyde, sulfuric acid and/or acetic acid can performed by filtration of the reaction mixture, using alkalis to wash the residue and neutralize the acids.

Suitable examples of alkalis can be water-soluble alkalis such as sodium hydroxide, potassium hydroxide, ammonium hydroxyde and sodium carbonate. “Water-soluble” means that not only alkalis themselves are water-soluble but also the salts to be formed by their reaction with acids are water-soluble. Moreover, “alkali” means a substance which can neutralize an acid and its examples are hydroxides and weak acid salts such as carbonates of alkali metals and alkaline earth metals. For example, sodium hydroxide can be used during the filtration process as it is readily available and soluble in many acids.

Methods of the present disclosure may further comprise: cooling the mix comprising an isotropic pitch composition to ambient temperature; and separating the isotropic pitch composition from any remaining paraformaldehyde, sulfuric acid and/or acetic acid.

In some instances, mixing the second mixture comprising sulfuric acid and acetic acid to the first mixture may be carried out at atmospheric pressure.

Methods of the present disclosure may be carried out without use of solvent (i.e., neat mixing the aromatic feedstock, the acetic acid, and the formaldehyde, for instance). In some instance, solvents used for producing the isotropic pitch composition may be miscible with the aromatic feedstock, the formaldehyde, and/or the acids.

### End Uses

Isotropic pitch compositions of the present disclosure may be used as a precursor for the production of mesophase pitches, and further for carbon fiber manufacture to improve the production of highly oriented carbon fibers with excellent mechanical properties, as well as normal paraffin hydrocarbons (NHP), or tackifiers.

In some instances, methods of the present disclosure may comprise: mixing an aromatic feedstock comprising one or more aromatic classes with paraformaldehyde, in the presence of acetic acid at ambient temperature to produce a first mixture; heating the first mixture at a temperature of about 40° C. to about 300° C.; mixing a second mixture comprising sulfuric acid and acetic acid to the first mixture at a temperature of about 40° C. to about 300° C. to form a mix comprising an isotropic pitch composition, wherein the isotropic pitch composition comprises: at least two monomers linked with at least one methylene bridge between each one of the at least two monomers, wherein each one of the at least monomers comprises one or more aromatic classes, and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition; and hydrotreating the isotropic pitch composition to produce a mesophase pitch suitable for spinning into carbon fibers.

Further, the isotropic pitch composition may have a weight average molecular weight (Mw) of about 300 g/mol to about 750 g/mol. The isotropic pitch composition may comprise or consist essentially of dimers, trimers, tetramers, pentamers, and any combination thereof. In some cases, the isotropic pitch composition may comprise or consist essentially of trimers and tetramers.

Isotropic pitch compositions of the present disclosure may also be used as additives for fluid applications.

Isotropic pitch compositions of the present disclosure with low Mw and high Tg (typically a low molecular weight ranging from about 400 to 5000 g/mol; the glass transition temperature ranging from the room temperature to 200° C.) may also be used as a precursor for tackifier, upon hydrogenation of the said Isotropic pitch compositions (i.e., reduction of the aromatics).

Embodiments disclosed herein include:
A. Isotropic pitch compositions. The isotropic pitch compositions comprise: at least two monomers linked with at least one methylene bridge between each one of the at least two monomers, wherein each one of the at least monomers comprises one or more aromatic classes comprising one or more 5-membered rings, 6-membered rings, and any combination thereof; and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition.
B. Methods for making isotropic pitch compositions. The methods comprise: mixing an aromatic feedstock comprising one or more aromatic classes with formaldehyde or paraformaldehyde, in the presence of acetic acid at ambient temperature to produce a first mixture; heating the first mixture at a temperature of about 40° C. to about 300° C.; mixing a second mixture comprising sulfuric acid and acetic acid to the first mixture at a temperature of about 40° C. to about 300° C. to form a mix comprising an isotropic pitch composition, wherein the isotropic pitch composition comprises: at least two monomers linked with at least one methylene bridge between each one of the at least two monomers, wherein each one of the at least monomers comprises the one or more aromatic classes comprising one or more 5-membered rings, 6-membered rings, and any combination thereof; and wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition.
C. Methods for making isotropic pitch compositions. The methods comprise: mixing an aromatic feedstock comprising one or more aromatic classes with formaldehyde or paraformaldehyde, in the presence of acetic acid at ambient temperature to produce a first mixture; heating the first mixture at a temperature of about 40° C. to about 300° C.; mixing a second mixture comprising sulfuric acid and acetic acid to the first mixture at a temperature of about 40° C. to about 300° C. to form a mix comprising an isotropic pitch composition, wherein the isotropic pitch composition comprises: at least two monomers linked with at least one methylene bridge between each one of the at least two monomers, wherein each one of the at least monomers comprises the one or more aromatic classes comprising one or more 5-membered rings, 6-membered rings, and any combination thereof; wherein the isotropic pitch composition has a weight average molecular weight (Mw) of about 300 g/mol to about 1,500 g/mol, a softening point (Tₛₚ) of 90° C. or greater, and a micro carbon residue (MCR) of about 18 wt % or greater, based on the total weight of the isotropic pitch composition; and hydrotreating the isotropic pitch composition to produce a mesophase pitch suitable for spinning into carbon fibers.

Embodiments A, B, and C may have one or more of the following elements in any combination:

Element 1: wherein the isotropic pitch composition has a weight average molecular weight (Mw) of about 300 g/mol to about 750 g/mol, and wherein the isotropic pitch composition comprises or consists essentially of dimers, trimers, tetramers, pentamers, and any combination thereof.

Element 2: wherein each one of the one or more aromatic classes are unsubstituted aromatics and/or substituted aromatics selected from the group consisting of 1-ring aromatics (ARC1), 2-ring aromatics (ARC2), 3-ring aromatics (ARC3), 4 or more-ring aromatics (ARC4), 5-ring aromatics (ARC5), 6-ring aromatics (ARC6), 7-ring aromatics (ARC7), 8-ring aromatics (ARC8), 9-ring aromatics (ARC9), 10 or more-ring aromatics (ARC10+), and any combination thereof.

Element 3: wherein the substituted aromatics are selected from the group consisting of C₁ to C₂₀ hydrocarbyl monosubstituted aromatics, C₁ to C₂₀ hydrocarbyl disubstituted aromatics, C₁ to C₂₀ hydrocarbyl trisubstituted aromatics, and any combination thereof.

Element 4: wherein the isotropic pitch composition comprises: 0.1 wt % to 100 wt % ARC1, 0.1 wt % to 100 wt % ARC2, 0.1 wt % to 100 wt % ARC3, 0.1 wt % to 100 wt % ARC4, 0.1 wt % to 100 wt % ARC5, 0.1 wt % to 100 wt % ARC6, 0.1 wt % to 100 wt % ARC7, 0.1 wt % to 100 wt % ARC8, 0.1 wt % to 100 wt % ARC9, 0.1 wt % to 100 wt % ARC10+, based on the total weight of the isotropic pitch composition.

Element 5: wherein the isotropic pitch composition comprises: 0.1 wt % to 100 wt % ARC1, 0.1 wt % to 100 wt % ARC2, 0.1 wt % to 80 wt % ARC3, 0.1 wt % to SO wt % ARC4, 0.1 wt % to 50 wt % ARC5, 0.1 wt % to 25 wt % ARC6, 0.1 wt % to 25 wt % ARC7, 0 wt % to 10 wt % ARC8, 0 wt % to 10 wt % ARC9, 0 wt % to 5 wt % ARC10+, based on the total weight of the isotropic pitch composition.

Element 6: wherein each one of the one or more aromatic classes comprise partially hydrogenated aromatic rings.

Element 7: wherein each one of the one or more aromatic classes are selected from the group consisting of benzene, toluene, xylenes (such as ortho-, meta-, para-xylene), naphthalene, 1-methyl naphthalene, 2-methyl naphthalene, anthracene, phenanthrene, pyrene, benzopyrene, picenecoronene, chrysene, tetracene, pentacene, triphenylene, corannulene, benzo[j]fluoranthene, Benzo[c]fluorene, perylene, benzo-perylene, ovalene, AROMATIC-200™, and any combination thereof.

Element 8: wherein Tₛₚ is about 400° C. or less.

Element 9: wherein the isotropic pitch composition has a transition glass temperature (T_{g}) ranging from about 50° C. to about 200° C.

Element 10: wherein the isotropic pitch composition has an MCR of about 40 wt % or less, based on the total weight of the isotropic pitch composition.

Element 11: wherein the isotropic pitch composition is used as a precursor for producing mesophase pitch compositions, carbon fibers, carbon fiber composites, normal paraffin hydrocarbons, tackifiers.

Element 12: wherein the isotropic pitch composition has a weight average molecular weight (Mw) of about 300 g/mol to about 750 g/mol, wherein the isotropic pitch composition comprises or consists essentially of dimers, trimers, tetramers, pentamers, and any combination thereof.

Element 13: wherein each one of the one or more aromatic classes are unsubstituted aromatics and/or substituted aromatics selected from the group consisting of 1-ring aromatics (ARC1), 2-ring aromatics (ARC2), 3-ring aromatics (ARC3), 4 or more-ring aromatics (ARC4), 5-ring aromatics (ARC5), 6-ring aromatics (ARC6), 7-ring aromatics (ARC7), 8-ring aromatics (ARC8), 9-ring aromatics (ARC9), 10 or more-ring aromatics (ARC10+), and any combination thereof.

Element 14: wherein the substituted aromatics are selected from the group consisting of C₁ to C₂₀ hydrocarbyl monosubstituted aromatics, C₁ to C₂₀ hydrocarbyl disubstituted aromatics, C₁ to C₂₀ hydrocarbyl trisubstituted aromatics, and any combination thereof.

Element 15: wherein each one of the one or more aromatic classes comprise partially hydrogenated aromatic rings.

Element 16: wherein each one of the one or more aromatic classes are selected from the group consisting of benzene, toluene, xylenes (such as ortho-, meta-, para-xylene), naphthalene, 1-methyl naphthalene, 2-methyl naphthalene, anthracene, phenanthrene, pyrene, benzopyrene, picenecoronene, chrysene, tetracene, pentacene, triphenylene, corannulene, benzo[j]fluoranthene, Benzo[c]fluorene, perylene, benzo-perylene, ovalene, AROMATIC-200™, and any combination thereof.

Element 17: further comprising: cooling the mix to ambient temperature; and separating the isotropic pitch composition from any remaining formaldehyde or paraformaldehyde, sulfuric acid and/or acetic acid.

Element 18: wherein the molar ratio aromatic feedstock: formaldehyde (or paraformaldehyde) is from about 10:1 to about 1:10.

Element 19: wherein the molar ratio aromatic feedstock: formaldehyde (or paraformaldehyde) is 1:3.

Element 20: wherein the molar ratio aromatic feedstock: sulfuric acid is from about 1:0.001 to about 1:20.

Element 21: wherein the molar ratio aromatic feedstock: sulfuric acid is 1:1.

Element 22: wherein mixing the second mixture comprising sulfuric acid and acetic acid to the first mixture is carried out at atmospheric pressure.

Element 23: wherein the isotropic pitch composition comprises: 0.1 wt % to 100 wt % ARC1, 0.1 wt % to 100 wt % ARC2, 0.1 wt % to 100 wt % ARC3, 0.1 wt % to 100 wt % ARC4, 0.1 wt % to 100 wt % ARC5, 0.1 wt % to 100 wt % ARC6, 0.1 wt % to 100 wt % ARC7, 0.1 wt % to 100 wt % ARC8, 0.1 wt % to 100 wt % ARC9, 0.1 wt % to 100 wt % ARC10+, based on the total weight of the isotropic pitch composition.

Element 24: wherein the isotropic pitch composition comprises: 0.1 wt % to 100 wt % ARC1, 0.1 wt % to 100 wt % ARC2, 0.1 wt % to 80 wt % ARC3, 0.1 wt % to 50 wt % ARC4, 0.1 wt % to 50 wt % ARC5, 0.1 wt % to 25 wt % ARC6, 0.1 wt % to 25 wt % ARC7, 0 wt % to 10 wt % ARC8, 0 wt % to 10 wt % ARC9, 0 wt % to 5 wt % ARC10+, based on the total weight of the isotropic pitch composition.

Element 25: wherein the isotropic pitch composition has a Tₛₚ of about 400° C. or less.

Element 26: wherein the isotropic pitch composition has a transition glass temperature (T_{g}) ranging from about 50° C. to about 200° C.

Element 27: wherein the isotropic pitch composition has an MCR of about 40 wt % or less, based on the total weight of the isotropic pitch composition.

Element 28: wherein the isotropic pitch composition has a weight average molecular weight (Mw) of about 300 g/mol to about 750 g/mol, wherein the isotropic pitch composition comprises or consists essentially of dimers, trimers, tetramers, pentamers, and any combination thereof.

Element 29: wherein each one of the one or more aromatic classes are unsubstituted aromatics and/or substituted aromatics selected from the group consisting of 1-ring aromatics (ARC1), 2-ring aromatics (ARC2), 3-ring aromatics (ARC3), 4 or more-ring aromatics (ARC4), 5-ring aromatics (ARC5), 6-ring aromatics (ARC6), 7-ring aromatics (ARC7), 8-ring aromatics (ARC8), 9-ring aromatics (ARC9), 10 or more-ring aromatics (ARC10+), and any combination thereof.

By way of non-limiting example, exemplary combinations applicable to A include, but are not limited to: 1 or 2, and 3; 1 or 2, and 4; 1 or 2, and 5; 1 or 2, and 6; 1 or 2, and 6 and 7; 1 or 2, and 7; 1 or 2, and 8; 1 or 2, and 6-8; 1 or 2, and 7 and 8; 1 or 2, and 9; 1 or 2, and 6-9; 1 or 2, and 11; 1 or 2, and 3 and 4; 1 or 2, and 5; 6 and 7; 6 and 8; and 6 and 9.

By way of non-limiting example, exemplary combinations applicable to B include, but are not limited to: 12 or 13, and 14; 12 or 13, and 15; 12 or 13, and 16; 12 or 13, and 17; 12 or 13, and 18; 12 or 13, and 19; 12 or 13, and 20; 12 or 13, and 21; 12 or 13, and 22; 12 or 13, and 23; 12 or 13, and 24; 12 or 13, and 25; 12 or 13, and 26; 12 or 13, and 27; 12 or 13, and 14-23; 12 or 13, and 15 and 16; 12 or 13, and 15; 16 and 17; 16 and 18; and 16 and 19; 18 or 19, and 21; 18 or 19, and 22; 18 or 19, and 23; 18 or 19, and 23 and 24; 18 or 19, and 26; 21 or 22, and 23; 21 or 22, and 23 and 24; 23 and 25; and 23 and 26.

By way of non-limiting example, exemplary combinations applicable to B include, but are not limited to: 28 or 29, and 14; 28 or 29, and 14; 28 or 29, and 15; 28 or 29, and 16; 28 or 29, and 17; 28 or 29, and 23 and 24; 23 and 25; and 27 and 26.

To facilitate a better understanding of the embodiments of the present disclosure, the following examples of preferred or representative embodiments are given. In no way should the following examples be read to limit, or to define, the scope of the present disclosure.

### EXAMPLES

Paraformaldehyde, sulfuric acid, ammonium hydroxide, naphthalene, 1-methylnaphthalene, 2-methylnaphthalene, anthracene, phenanthrene, pyrene, toluene, and p-xylene were obtained from Sigma-Aldrich and were used as received, unless otherwise noted. AROMATIC-200™ Fluid, also referred to as AR-200™ (e.g., SOLVESSO™ 200 Fluid) was obtained from ExxonMobil Chemical Company and used as received.

Various reaction conditions were applied to ascertain thermal properties of the synthesized isotropic pitch compositions. The results obtained herein showed that the softening points of the synthesized isotropic pitch compositions was dependent of the reaction conditions, and reagents or reactants. Remarkably, the softening points increased particularly with the reaction time, the amount of sulfuric acid and paraformaldehyde. The isotropic pitch compositions were obtained in excellent yields ranging from 69% to 99%.

### Synthesis of Isotropic Pitch Compositions

Aromatic(s) and paraformaldehyde were dissolved in acetic acetic at ambient temperature. Acetic acid and sulfuric acid were both used neat. A solution mixture of sulfuric acid and acetic acid was added dropwise at 40° C. over 30 minutes. The resulting cloudy suspension was stirred vigorously for 7 hours at various temperature. No water was present in the reaction. The resulting product mixture was cooled to ambient temperature, poured into ice water, and filtered. The filter cake was washed with water, ammonium hydroxide solution (50% solution) in order to remove any residual acids, and allowed to dry at 40° C. under vacuum for overnight. The isotropic pitch compositions were analyzed by Fourier-transform ion cyclotron resonance (FTICR) analysis, ¹H NMR (400 MHz, toluene-d₆), and ¹³C NMR (125 MHz, toluene-d₆). Said FTICR, ¹H NMR, and ¹³C NMR showed that the starting materials have been quantitatively consumed. The isotropic pitch compositions were washed with a basic solution to remove any residual acids. Further, based on the mass spectrometry data analysis, relatively low oxygen content (less than 5%) was observed.

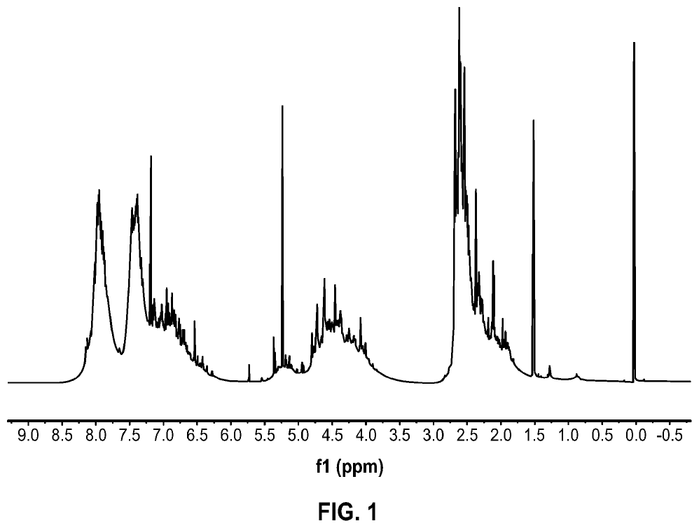

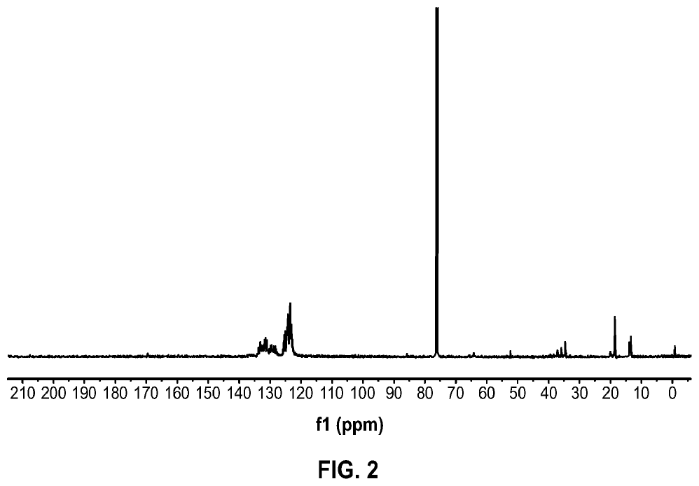

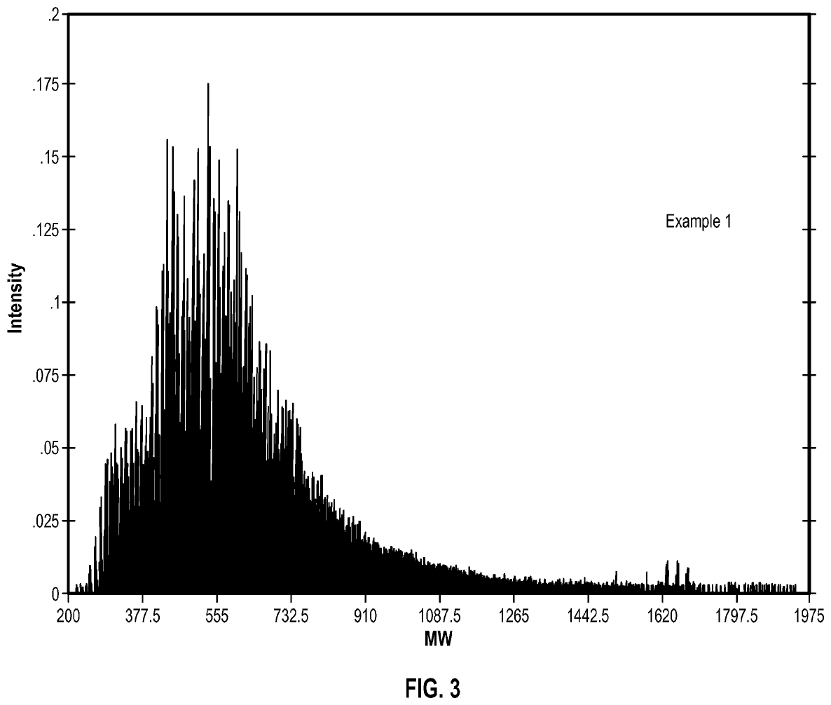

Synthesis of 1-Methylnaphthalene Synthetic Pitch Composition (Example 1) 1-Methylnapthalene (5 g, 35.2 mmol, 1 equiv) and paraformaldehyde (3.16 g, 105.5 mmol, 3 equiv) were dissolved in acetic acid (45 mL) at ambient temperature. Sulfuric acid mixture (34.5 g, 352 mmol, 10 equiv) in 20 mL of acetic acid was added dropwise at 40° C. over 30 minutes. The cloudy suspension was stirred vigorously for 7 hours at 90° C. The cloudy brown product mixture was cooled to ambient temperature, poured into ice water, and filtered. The filter cake was washed with water, ammonium hydroxide solution (50% solution) and allowed to dry at 40° C. under vacuum for overnight. Example 1 was obtained as a brown solid (91% Yield). Scheme 3 illustrates various examples of molecular structures (e.g., dimer with an Mw of 296.16 g/mol; trimer with an Mw of 450.23 g/mol; tetramer with an Mw of 604.31 g/mol; pentamer with an Mw of 758.39 g/mol; hexamer with an Mw of 912.47 g/mol) obtained for the isotropic 1-methyl naphthalene pitch composition (Example 1) synthesized using paraformaldehyde in the presence of sulfuric acid and acetic acid. FIG. 1 is a 400 MHz ¹H NMR spectrum of an isotropic 1-methyl naphthalene pitch composition in CDCl₃, in accordance with some embodiments of the present disclosure. FIG. 2 is a 400 MHz ¹³C NMR spectrum of an isotropic 1-methyl naphthalene pitch composition in CDCl₃, in accordance with some embodiments of the present disclosure. FIG. 3 is a Fourier-transform ion cyclotron resonance (FT-ICR) mass spectrum of isotropic 1-methyl naphthalene pitch composition, in accordance with some embodiments of the present disclosure.

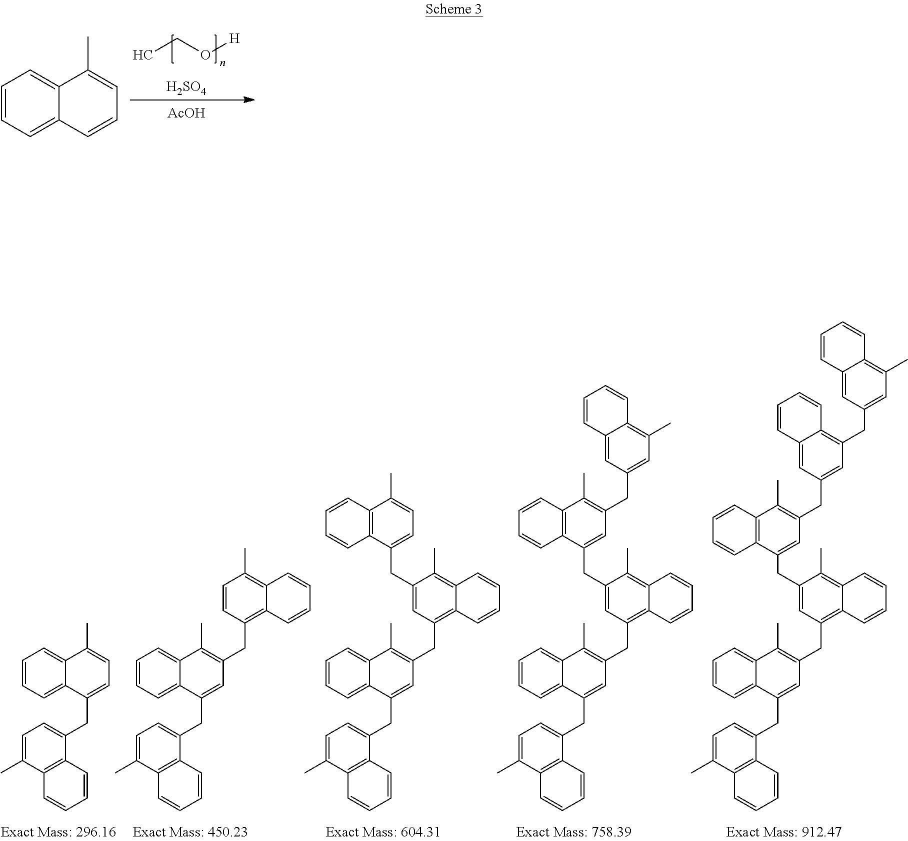

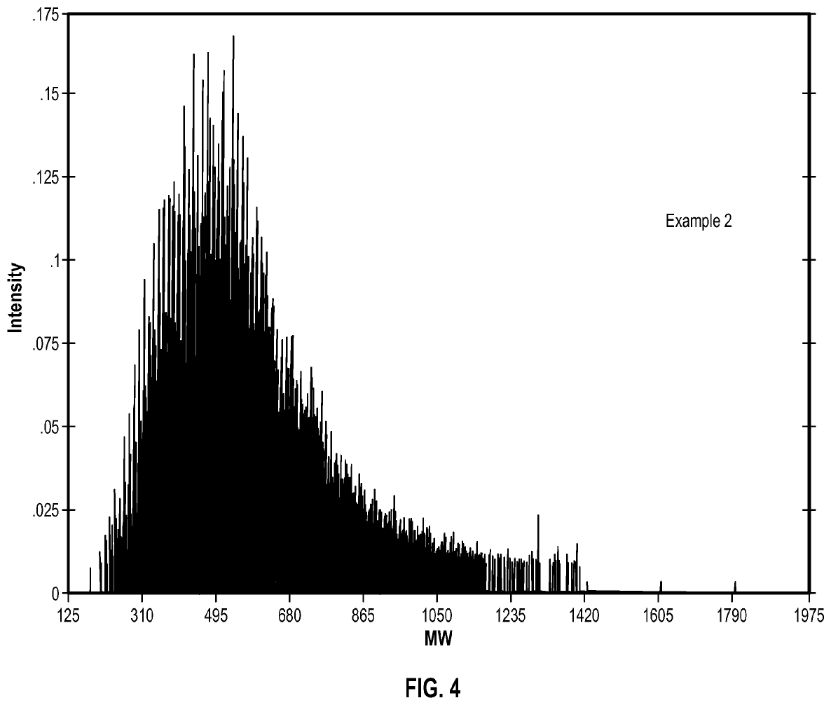

Synthesis of Toluene Synthetic Pitch Composition (Example 2). Toluene (5 g, 54.2 mmol, 1 equiv) and paraformaldehyde (4.88 g, 162.7 mmol, 3 equiv) were dissolved in acetic acid (45 mL) at ambient temperature. Sulfuric acid mixture (34.5 g, 352 mmol, 10 equiv) in 20 mL of acetic acid was added dropwise at 40° C. over 30 minutes. The resulting cloudy suspension was stirred vigorously for 7 hours at 90° C. The cloudy brown product mixture was cooled to ambient temperature, poured into ice water, and filtered. The filter cake was washed with water, ammonium hydroxide solution and allowed to dry at 40° C. under vacuum for overnight. Example 2 was obtained as a brown solid (99% Yield). Scheme 4 illustrates various examples of molecular structures (e.g., trimer with an Mw of 300.19 g/mol; tetramer with an Mw of 404.25 g/mol, hexamer with an Mw of 612.38 g/mol) for the isotropic toluene pitch composition (Example 2) synthesized using paraformaldehyde in the presence of sulfuric acid and acetic acid. FIG. 4 is a mass spectrum of the isotropic toluene pitch composition, in accordance with some embodiments of the present disclosure.

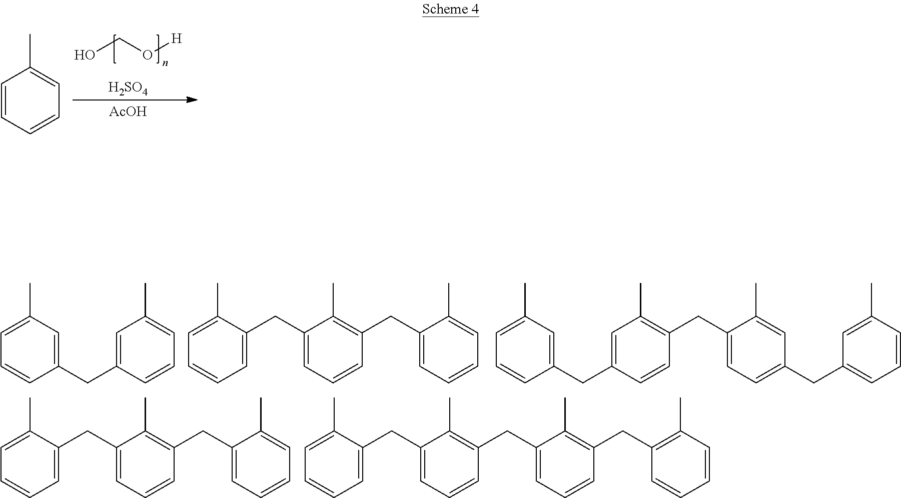

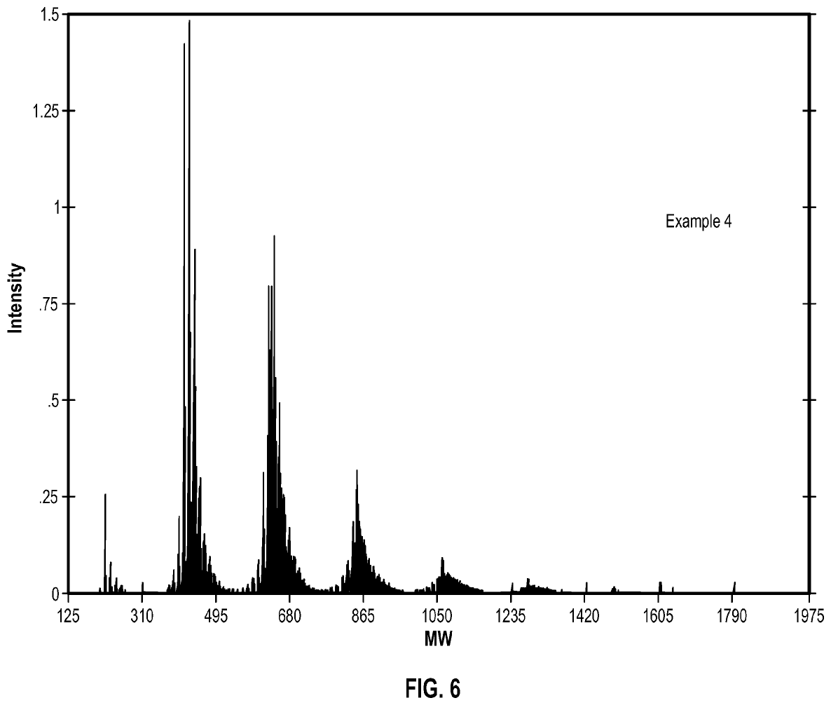

Synthesis of Phenanthrene Synthetic Pitch Composition (Example 3). The same synthetic procedure as described for 1-methyl naphthalene was applied for phenanthrene. Scheme 5 illustrates various examples of molecular structures (e.g., trimer with an Mw of 558.23 g/mol; tetramer with an Mw of 748.31 g/mol) for the isotropic phenanthrene pitch composition (Example 3) synthesized using paraformaldehyde in the presence of sulfuric acid and acetic acid. Example 3 was obtained as a brown solid (69%). FIG. 6 is a mass spectra of the pyrene pitch composition, in accordance with some embodiments of the present disclosure.

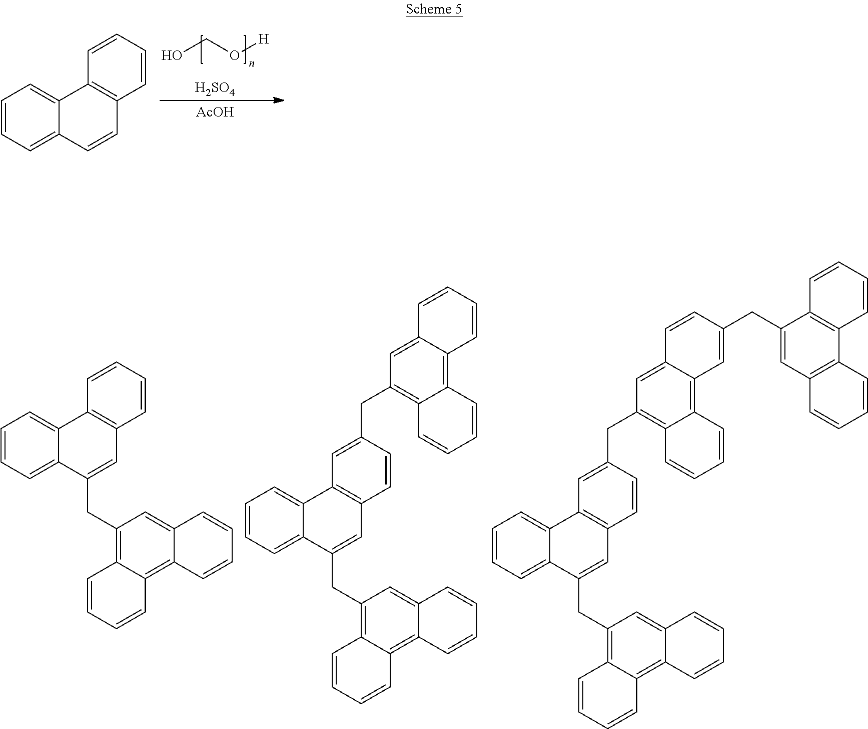

Synthesis of Pyrene Synthetic Pitch Composition (Example 4): The same synthetic procedure as described for 1-methyl naphthalene was applied for pyrene. Scheme 6 illustrates various examples of molecular structures (e.g., trimer with an Mw of 632.25 g/mol; trimer with an Mw of 636.28 g/mol) for the isotropic pyrene pitch composition (Example 4) synthesized using paraformaldehyde in the presence of sulfuric acid and acetic acid. Example 4 was obtained as a brown solid (78%).

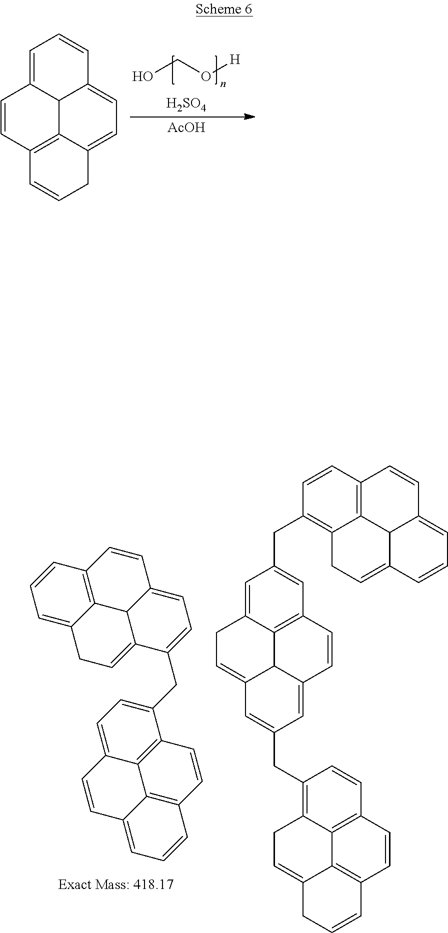

Synthesis of AR-200 Synthetic Pitch Composition (Example 5). The same synthetic procedure as described for 1-methyl naphthalene was applied for AR-200. Scheme 7 illustrates various examples of molecular structures for the isotropic AR-200 pitch composition (Example 5) synthesized using paraformaldehyde in the presence of sulfuric acid and acetic acid. Example 5 was obtained as a brown solid (96%).

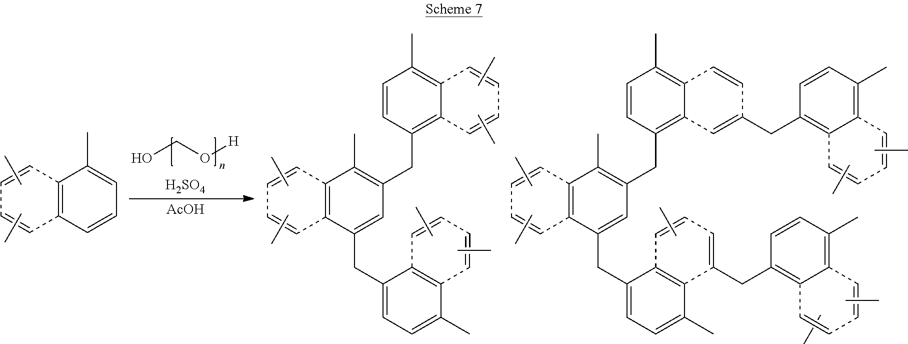

Synthesis of Mixed Synthetic Pitch Composition using Naphthalene and phenanthrene (Example 6). The same synthetic procedure as described for 1-methyl naphthalene was applied for a mixture of naphthalene and phenanthrene. Scheme 8 illustrates various examples of molecular structures for the mixed isotropic pitch composition (Example 6) synthesized using paraformaldehyde and 1:1 molar ratio of naphthalene and phenanthrene in the presence of sulfuric acid and acetic acid. Example 6 was obtained as a brown solid (99%).

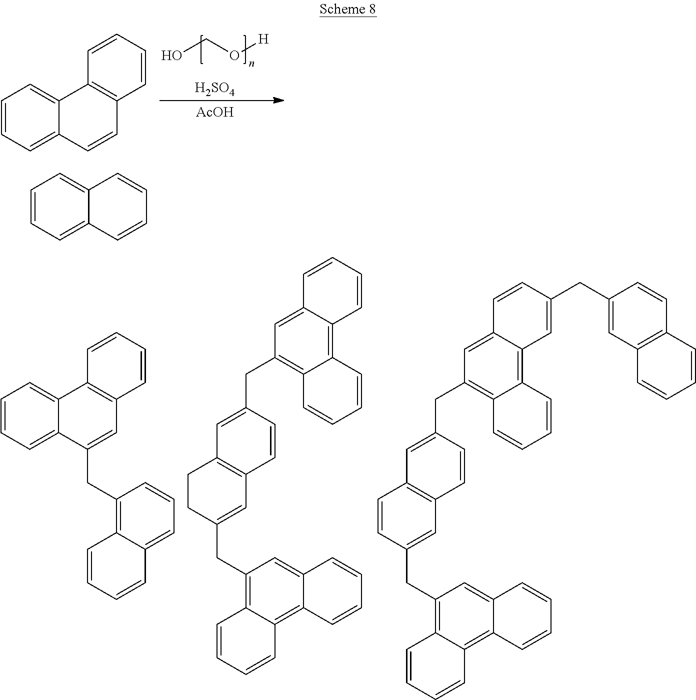

Synthesis of Tetraline Synthetic Pitch Composition (Example 7). The same synthetic procedure as described for 1-methyl naphthalene was applied for tetraline. Scheme 9 illustrates various examples of molecular structures for the isotropic tetraline pitch composition (Example 6) synthesized using paraformaldehyde in the presence of sulfuric acid and acetic acid. Example 6 was obtained as a brown solid (97%).

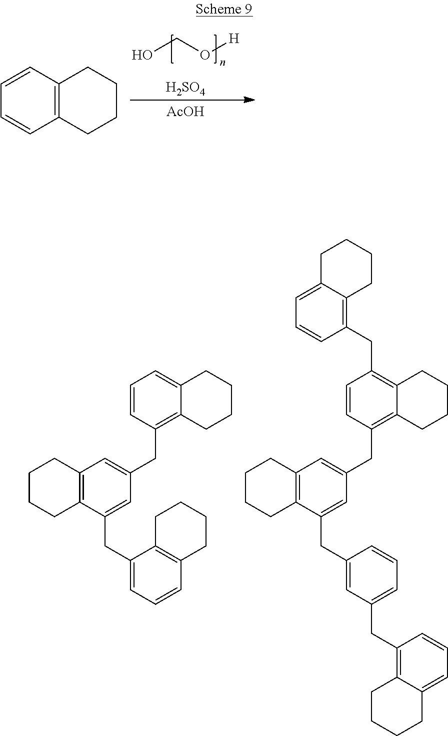

Synthesis of Mixed Synthetic Pitch Composition using Tetraline and 1-Methyl naphthalene (Example 8). The same synthetic procedure as described for 1-methyl naphthalene was applied for a mixture of tetraline and 1-methyl naphthalene. Scheme 10 illustrates various examples of molecular structures for the mixed isotropic pitch composition (Example 8) synthesized using paraformaldehyde and 1:1 molar ratio of tetraline and 1-methyl naphthalene in the presence of sulfuric acid and acetic acid. Example 8 was obtained as a brown solid (98%).

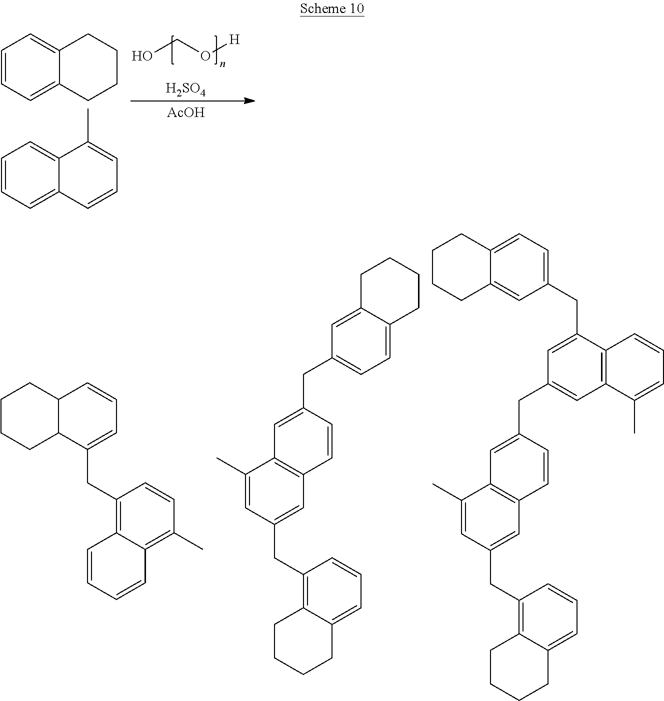

Structure of the isotropic pitch compositions was evaluated using Fourier-transform ion cyclotron resonance (FTICR) analysis. FIG. 3 illustrates the field desorption (FD) spectra of the isotropic 1-methyl naphthalene pitch composition (Example 1). The molecular weight of the constituents in the isotropic 1-methyl naphthalene pitch composition (Example 1) distributed from 224 to 1500 with a maximum abundances at m/z 268, 408, 548, 688, 828, and 968 indicating that the starting material was completely consumed under the above described conditions. Based on these results, the molecular structures of the isotropic 1-methyl naphthalene pitch composition (Example 1) are represented by the schematic chemical structure shown in Scheme 3.

¹H NMR (400 MHz, CDCl₃) was used to further elucidate the hydrogen content. For example, the ¹H NMR spectrum of the synthesized 1-methyl naphthalene synthetic pitch composition (Example 1) shown in FIG. 1 exhibits benzylic hydrogens between 3.5 ppm and 4.5 ppm. The said benzylic protons indicated a methylene linkage between the aromatic molecules. The number of remaining aromatic hydrogens in the 1-methyl naphthalene synthetic pitch composition (Example 1) was depicted by the aromatic region from about 6.5 ppm to about 8 ppm.

Similarly, the presence of methyl carbons between 10 ppm and 25 ppm, benzylic carbons between 30 ppm and 70 ppm, and aromatic carbons between 120 ppm and 140 ppm are shown in FIG. 2, which illustrate the ¹³C NMR spectrum (in CDCl₃ of the isotropic 1-methyl naphthalene pitch composition (Example 1).

FIG. 4 illustrates the mass spectra of an isotropic toluene pitch composition (Example 4). The peaks ranged from 200 to 1400 with the largest one at 500. The major peaks indicated the presence of trimers to decamers of the toluene oligomers. It is noted that the distribution was almost continuous, suggesting a series of alkyl side chains is present in the constituent molecules.

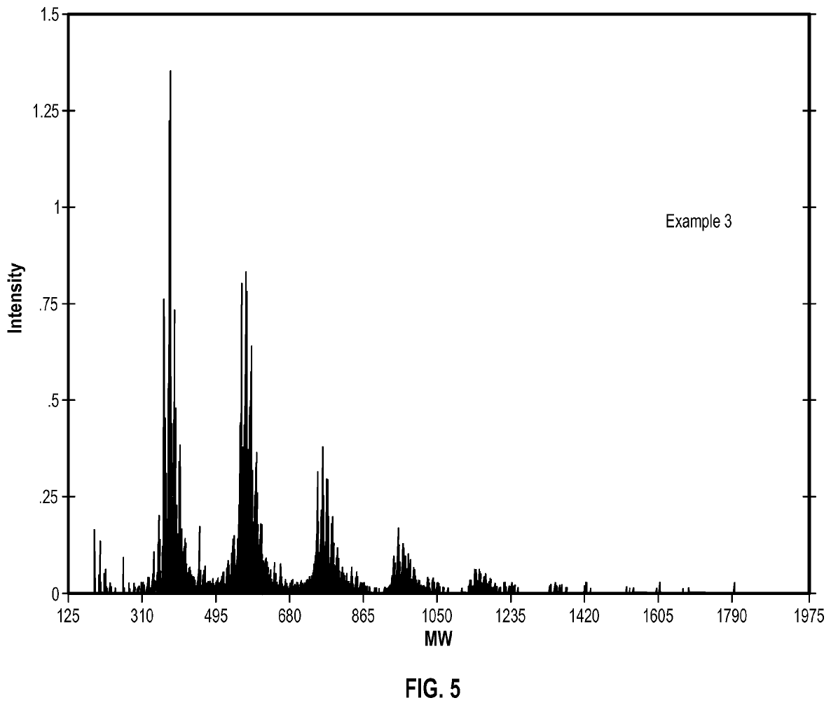

FIG. 5 illustrates the field desorption (FD) spectra of the isotropic phenanthrene pitch composition (Example 3). The major peaks indicated the presence of dimers, trimers, tetramers, pentamers, hexamers and heptamers of the phenanthrene oligomers.

FIG. 6 illustrates the field desorption (FD) spectra of the isotropic pyrene pitch composition (Example 4). The isotropic pyrene pitches showed a distribution from dimers to heptamers. The molecular weights of the maximum abundances at m/z 468 indicating that the starting material was completely consumed under the above described conditions. Based on the result, the molecular structures of the isotropic pyrene pitches composition (Example 4) are represented by the schematic chemical structure shown in Scheme 6.

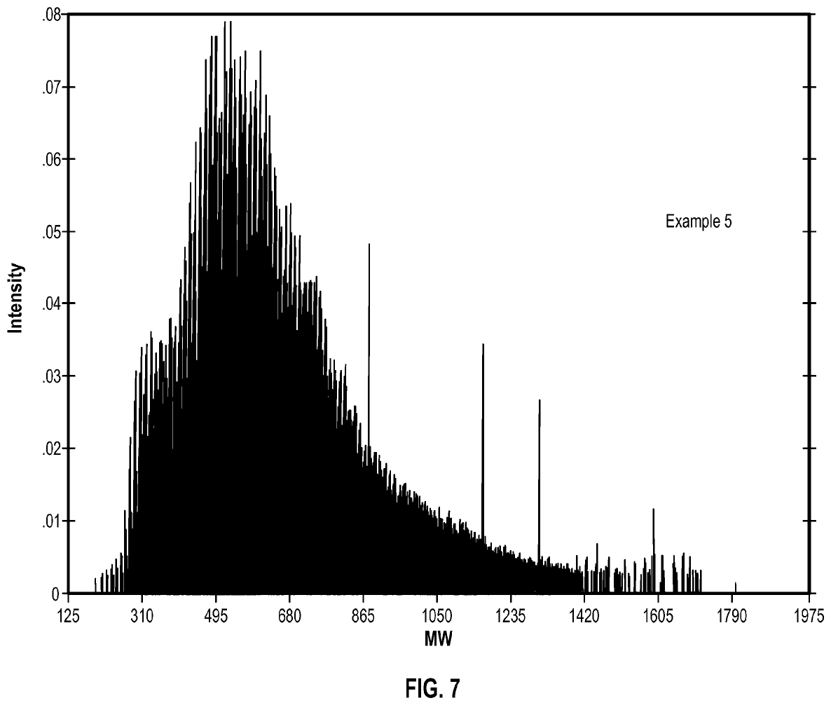

FIG. 7 illustrates the field desorption (FD) spectra of the isotropic AR-200 pitch composition (Example 5). The peaks ranged from m/z 200 to m/z 1400 with the largest around m/z 500. The major peaks indicated the presence of trimers to decamers of the AR-200 oligomers. It is noted that the distribution was almost continuous, suggesting a series of alkyl side chains is present in the constituent molecules.

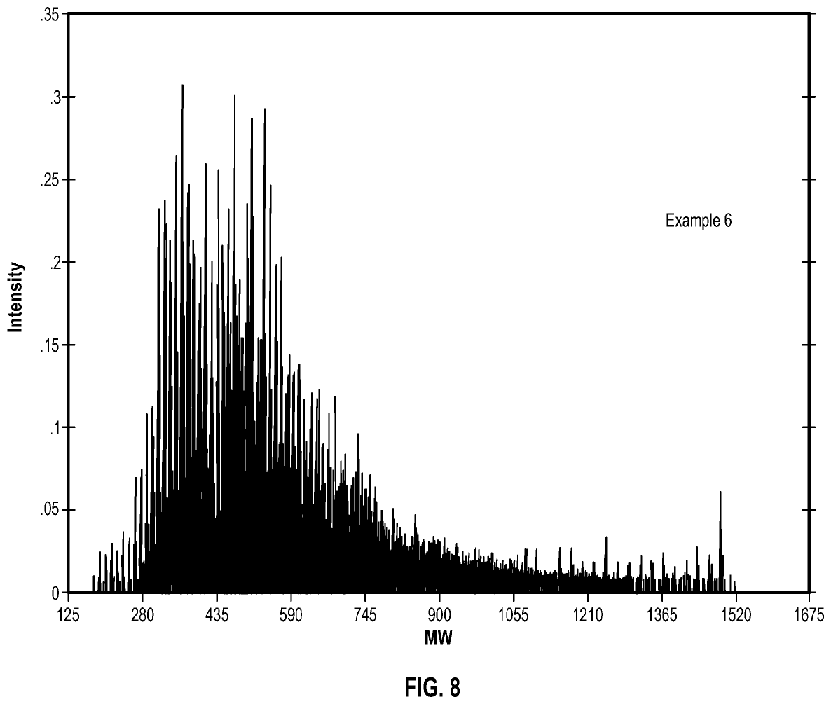

FIG. 8 illustrates the field desorption (FD) spectra of the mixed isotropic pitch composition of naphthalene and phenanthrene (Example 6). The distribution was almost continuous from m/z 250 to m/z 1520 suggesting various constituent isomeric molecules.

Synthesis of 1-methylnaphthalene pitch compositions under various conditions. 1-Methylnapthalene (5 g, 35.2 mmol, 1 equiv) and paraformaldehyde (3.28 g, 105.5 mmol, 3 equiv) were dissolved in acetic acid (45 mL) at ambient temperature. Various amount of sulfuric acid in 20 mL of acetic acid was added dropwise at 40° C. over 30 minutes. The resulting cloudy suspension was stirred vigorously for 24 hours at 90° C. The resulting cloudy brown product mixture was cooled to ambient temperature, poured into ice water and neutralized with ammonium hydroxide solution, and filtered. The filter cake was washed with water and allowed to dry overnight. The resulting light yellowish solid was dried in vacuum at 40° C. Table 1 summarizes the experimental conditions and thermal characteristics of 1-methylnaphthalene synthetic pitch compositions produced under various conditions, for 24 hours (Examples 7-15), illustrating the effect of sulfuric acid on the softening point. Values of the softening point of the pitch composition was tunable according to the amount of H₂SO₄ employed.

TABLE 1

| | 1-Methyl | | Acetic | | | | |
|---|---|---|---|---|---|---|---|
| | Naphthalene | Paraformaldehyde | Acid | H₂SO₄ | Time | Temperature | Tₛₚ |
| Example | (equiv) | (equiv) | (mL) | (equiv) | (hour) | (° C.) | (° C.) |
| 7 | 1.0 | 3.0 | 65 | 10 | 24 | 90 | >350 |
| 8 | 1.0 | 3.0 | 65 | 5 | 24 | 90 | >350 |
| 9 | 1.0 | 3.0 | 65 | 4 | 24 | 90 | >350 |
| 10 | 1.0 | 3.0 | 65 | 3 | 24 | 90 | >350 |
| 11 | 1.0 | 3.0 | 65 | 2.5 | 24 | 90 | 213 |
| 12 | 1.0 | 3.0 | 65 | 1.5 | 24 | 90 | 199 |
| 13 | 1.0 | 3.0 | 65 | 1.0 | 24 | 90 | 183 |
| 14 | 1.0 | 3.0 | 65 | 0.5 | 24 | 90 | 137 |
| 15 | 1.0 | 3.0 | 65 | 4 drops | 24 | 90 | 100 |

Table 2 summarizes the experimental conditions and thermal characteristics of 1-methylnaphthalene synthetic pitch compositions produced at various time, illustrating the effect of the reaction time on the Tsp and MCR (Examples 16-20).

TABLE 2

| | 1-Methyl | | Acetic | | | | | | |
|---|---|---|---|---|---|---|---|---|---|
| | Naphthalene | Paraformaldehyde | acid | H₂SO₄ | Time | Temperature | Yield | Tₛₚ | MCRT |
| Example | (equiv) | (equiv) | (mL) | (equiv) | (hour) | (° C.) | (%) | (° C.) | (%) |
| 16 | 1.0 | 3.0 | 65 | 1.0 | 2 | 90 | 83 | 170 | 30.2 |
| 17 | 1.0 | 3.0 | 65 | 1.0 | 4 | 90 | 85 | 179 | 31.4 |
| 18 | 1.0 | 3.0 | 65 | 1.0 | 6 | 90 | 92 | 258 | 31.9 |
| 19 | 1.0 | 3.0 | 65 | 1.0 | 8 | 90 | 84 | 152 | 27.7 |
| 20 | 1.0 | 3.0 | 65 | 1.0 | 24 | 90 | 91 | 180 | 29.2 |

Table 3 summarizes the experimental conditions and thermal characteristics of 1-methylnaphthalene synthetic pitch compositions produced at various paraformaldehyde concentration (Examples 21-23). As the concentration of paraformaldehyde increased, the value of Tₛₚ for each examples (Examples 21-23) increased.

TABLE 3

| | Paraformaldehyde | Acetic acid | H₂SO₄ | Time | Temperature | Yield | Tₛₚ | MCRT |
|---|---|---|---|---|---|---|---|---|
| Example | (equiv) | (mL) | (equiv) | (hour) | (° C.) | (%) | (° C.) | (%) |
| 21 | 1.0 | 65 | 1.0 | 24 | 90 | 83 | 142 | 29.8 |
| 22 | 1.5 | 65 | 1.0 | 24 | 90 | 86 | 165 | 25.4 |
| 23 | 3.0 | 65 | 1.0 | 24 | 90 | 91 | 181 | 29.2 |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed to herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

One or more illustrative incarnations incorporating one or more disclosure elements are presented herein. Not all features of a physical implementation are described or shown in this application for the sake of clarity. It is understood that in the development of a physical embodiment incorporating one or more elements of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the lower limit and upper limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. An isotropic pitch composition comprising: at least two monomers linked with at least one methylene bridge between each one of the at least two monomers, wherein each one of the at least monomers comprises one or more aromatic classes comprising one or more 5-membered rings, 6-membered rings, and any combination thereof; and wherein the isotropic pitch composition has a weight average molecular weight (Mw) of about 300 g/mol to about 1,500 g/mol, a softening point (TSp) of 90° C. or greater, and a micro carbon residue (MCR) of about 18 wt % or greater, based on the total weight of the isotropic pitch composition.

2. The isotropic pitch composition of claim 1, wherein the isotropic pitch composition has a weight average molecular weight (Mw) of about 300 g/mol to about 750 g/mol, and wherein the isotropic pitch composition comprises or consists essentially of dimers, trimers, tetramers, pentamers, and any combination thereof.

3. The isotropic pitch composition of claim 1, wherein each one of the one or more aromatic classes are unsubstituted aromatics and/or substituted aromatics selected from the group consisting of 1-ring aromatics (ARC1), 2-ring aromatics (ARC2), 3-ring aromatics (ARC3), 4 or more-ring aromatics (ARC4), 5-ring aromatics (ARC5), 6-ring aromatics (ARC6), 7-ring aromatics (ARC7), 8-ring aromatics (ARC8), 9-ring aromatics (ARC9), 10 or more-ring aromatics (ARC10+), and any combination thereof.

4. The isotropic pitch composition of claim 1, wherein the substituted aromatics are selected from the group consisting of Ci to C20 hydrocarbyl monosubstituted aromatics, Ci to C20 hydrocarbyl disubstituted aromatics, Ci to C20 hydrocarbyl trisubstituted aromatics, and any combination thereof.

5. The isotropic pitch composition of claim 1, comprising:
0.1 wt % to 100 wt % ARC1, 0.1 wt % to 100 wt % ARC2, 0.1 wt % to 100 wt % ARC3, 0.1 wt % to 100 wt % ARC4, 0.1 wt % to 100 wt % ARC5, 0.1 wt % to 100 wt % ARC6, 0.1 wt % to 100 wt % ARC7, 0.1 wt % to 100 wt % ARC8, 0.1 wt % to 100 wt % ARC9, 0.1 wt % to 100 wt % ARC10+, based on the total weight of the isotropic pitch composition.

6. The isotropic pitch composition of claim 1, comprising:
0.1 wt % to 100 wt % ARC1, 0.1 wt % to 100 wt % ARC2, 0.1 wt % to 80 wt % ARC3, 0.1 wt % to 50 wt % ARC4, 0.1 wt % to 50 wt % ARC5, 0.1 wt % to 25 wt % ARC6, 0.1 wt % to 25 wt % ARC7, 0 wt % to 10 wt % ARC8, 0 wt % to 10 wt % ARC9, 0 wt % to 5 wt % ARC10+, based on the total weight of the isotropic pitch composition.

7. The isotropic pitch composition of claim 1, wherein each one of the one or more aromatic classes comprise partially hydrogenated aromatic rings.

8. The isotropic pitch composition of claim 1, wherein each one of the one or more aromatic classes are selected from the group consisting of benzene, toluene, xylenes (such as ortho-, meta-, para-xylene), naphthalene, 1-methyl naphthalene, 2-methyl naphthalene, anthracene, phenanthrene, pyrene, benzopyrene, picenecoronene, chrysene, tetracene, pentacene, triphenylene, corannulene, benzo[j]fluoranthene, Benzo[c]fluorene, perylene, benzo-perylene, ovalene, AROMATIC-200™, and any combination thereof.

9. The isotropic pitch composition of claim 1, wherein Tsp is about 400° C. or less.

10. The isotropic pitch composition of claim 1, wherein the isotropic pitch composition has a transition glass temperature (T) ranging from about 50° C. to about 200° C.

11. The isotropic pitch composition of claim 1, wherein the isotropic pitch composition has an MCR of about 40 wt % or less, based on the total weight of the isotropic pitch composition.

12. The isotropic pitch composition of claim 1, wherein the isotropic pitch composition is used as a precursor for producing mesophase pitch compositions, carbon fibers, carbon fiber composites, normal paraffin hydrocarbons, tackifiers.

13. A method comprising: mixing an aromatic feedstock comprising one or more aromatic classes with formaldehyde or paraformaldehyde, in the presence of acetic acid at ambient temperature to produce a first mixture; heating the first mixture at a temperature of about 40° C. to about 300° C.; mixing a second mixture comprising sulfuric acid and acetic acid to the first mixture at a temperature of about 40° C. to about 300° C. to form a mix comprising an isotropic pitch composition, wherein the isotropic pitch composition comprises: at least two monomers linked with at least one methylene bridge between each one of the at least two monomers, wherein each one of the at least monomers comprises the one or more aromatic classes comprising one or more 5-membered rings, 6-membered rings, and any combination thereof; and wherein the isotropic pitch composition has a weight average molecular weight (Mw) of about 300 g/mol to about 1,500 g/mol, a softening point (TSp) of 90° C. or greater, and a micro carbon residue (MCR) of about 18 wt % or greater, based on the total weight of the isotropic pitch composition.

14. The isotropic pitch composition of claim 13, wherein the isotropic pitch composition has a weight average molecular weight (Mw) of about 300 g/mol to about 750 g/mol, wherein the isotropic pitch composition comprises or consists essentially of dimers, trimers, tetramers, pentamers, and any combination thereof.

15. The method of claim 13, wherein each one of the one or more aromatic classes are unsubstituted aromatics and/or substituted aromatics selected from the group consisting of 1-ring aromatics (ARC1), 2-ring aromatics (ARC2), 3-ring aromatics (ARC3), 4 or more-ring aromatics (ARC4), 5-ring aromatics (ARC5), 6-ring aromatics (ARC6), 7-ring aromatics (ARC7), 8-ring aromatics (ARC8), 9-ring aromatics (ARC9), 10 or more-ring aromatics (ARC10+), and any combination thereof.

16. The method of claim 13, wherein the substituted aromatics are selected from the group consisting of Ci to C20 hydrocarbyl monosubstituted aromatics, Ci to C20 hydrocarbyl disubstituted aromatics, Ci to C20 hydrocarbyl trisubstituted aromatics, and any combination thereof.

17. The method of claim 13, wherein each one of the one or more aromatic classes comprise partially hydrogenated aromatic rings.

18. The method of claim 13, wherein each one of the one or more aromatic classes are selected from the group consisting of benzene, toluene, xylenes (such as ortho-, meta- , para-xylene), naphthalene, 1-methyl naphthalene, 2-methyl naphthalene, anthracene, phenanthrene, pyrene, benzopyrene, picenecoronene, chrysene, tetracene, pentacene, triphenylene, corannulene, benzo[j]fluoranthene, Benzo[c]fluorene, perylene, benzo-perylene, ovalene, AROMATIC-200™, and any combination thereof.

19. The method of claim 13, further comprising:
cooling the mix to ambient temperature; and separating the isotropic pitch composition from any remaining formaldehyde or paraformaldehyde, sulfuric acid and/or acetic acid.

20. The method of claim 13, wherein the molar ratio aromatic feedstock: formaldehyde (or paraformaldehyde) is from about 10:1 to about 1:10.

21. The method of claim 13, wherein the molar ratio aromatic feedstock: formaldehyde (or paraformaldehyde) is 1:3.

22. The method of claim 13, wherein the molar ratio aromatic feedstock: sulfuric acid is from about 1:0.001 to about 1:20.

23. The method of claim 13, wherein the molar ratio aromatic feedstock: sulfuric acid is 1:1.

24. The method of claim 13, wherein mixing the second mixture comprising sulfuric acid and acetic acid to the first mixture is carried out at atmospheric pressure.

25. The methods of claim 13, wherein the isotropic pitch composition comprises: 0.1 wt % to 100 wt % ARC1, 0.1 wt % to 100 wt % ARC2, 0.1 wt % to 100 wt % ARC3, 0.1 wt % to 100 wt % ARC4, 0.1 wt % to 100 wt % ARC5, 0.1 wt % to 100 wt % ARC6, 0.1 wt % to 100 wt % ARC7, 0.1 wt % to 100 wt % ARC8, 0.1 wt % to 100 wt % ARC9, 0.1 wt % to 100 wt % ARC10+, based on the total weight of the isotropic pitch composition.

26.-32. (canceled)
